(19) United States
(12) Patent Application Publication
(10) Pub. No.: US 2019/0029188 A1
(43) Pub. Date: Jan. 31, 2019

(54) TREE-PLANTING STRUCTURE DEVICE

(71) Applicant: Hun Su KIM, Seoul (KR)

(72) Inventor: Hun Su KIM, Seoul (KR)

(21) Appl. No.: 16/147,095

(22) Filed: Sep. 28, 2018

Related U.S. Application Data
(63) Continuation of application No. PCT/KR2017/004049, filed on Apr. 14, 2017.

(30) Foreign Application Priority Data
Apr. 14, 2016 (KR) 10-2016-0045568

(51) Int. Cl. A01G 9/02; A01G 27/00

(52) U.S. Cl. CPC A01G 9/025; E01F 15/081; A01G 27/001

(57) ABSTRACT

A tree-planting structure device includes a securing net, an anchor, a plurality of stacking pouches and hooks. The securing net is formed in a size capable of covering a part of a guard, the ground, or a building outer wall and having an arrangement of a plurality of meshes. The anchor is coupled to the guard, the ground, or the building outer wall in order to fix a position of the securing net. The plurality of stacking pouches includes sacks coupled to the meshes for forming the securing net and respectively having plant growing soil contained therein. The stacking pouches are stacked while coming in contact with the securing net. The hooks include members for coupling the stacking pouches to the meshes of the securing net.

### CROSS REFERENCE

This application is a continuation of PCT Application No. PCT/KR2017/004049, filed on Apr. 14, 2017 and entitled “TREE-PLANTING STRUCTURE DEVICE,” which claims the benefit of Korean Patent Application No. 10-2016-0045568, filed on Apr. 14, 2016, disclosure of which are incorporated by reference in their entirety.

### TECHNICAL FIELD

Embodiments described herein generally relate to a tree-planting structure device and, more specifically, to a tree-planting structure device used in various types of base structures such as a building outer wall, a slope or foothill of a mountain, a median strip, and a guard rail.

### BACKGROUND

Recently, soil bags for growing plants are used to construct a retaining wall of a mountain slope around a road to provide an environmentally friendly landscape of the road. These soil bags lack a special coupling structure for stable construction, unlike existing retaining wall blocks. The related art such as Korean Patent Registration Nos. 10-0561696, and 10-1131556 disclose a technique for structurally stabilizing a retaining wall structure when the construction is performed by using the soil bags.

A road guard such as a median strip and a guard rail is formed to have various shapes and materials according to the traffic volume of the road, the average speed of vehicles passing the road, and the environment around the road. For the retaining wall, an inclined surface may be formed to stack the soil bags thereon by cutting or filling a mountain slope, a cutting area, or the like. However, it may be difficult to change a thickness or shape of the road guard such as a median strip and a guard rail which has been already installed. Accordingly, the above-described soil bag construction technique for the retaining wall may be rarely applied to the road guard such as the median strip and the guard rail.

Korean Patent Registration No. 10-1088719 discloses a four-season greening median strip configured to plant plants thereon, which may not be applied to the median strip already installed at the center or outer side of the road and available only to a place where a new road is constructed. Accordingly, the feasibility of installation may be remarkably lowered. In order to apply the related art to a place on which the median strip is already installed, a new median strip is required to be installed after the existing median strip is removed. The construction cost may significantly increase.

### SUMMARY

Systems and methods for providing a tree-planting structure device are described. In one embodiment, a tree-planting structure device includes a securing net, an anchor, a plurality of stacking pouches and a hook. The securing net has a size adapted to cover a part of a guard, a ground, or a building outer wall, and includes an array of a plurality of meshes. The anchor is coupled to the guard, the ground or the building outer wall to fix a position of the securing net. The plurality of stacking pouches is fastened to the array of the plurality of meshes, and stacking pouches include a sack containing soils for growing plants. The stacking pouches are stacked along the securing net while coming into contact with the securing net. The hook includes a member for fastening the stacking pouches to the array of meshes of the securing net.

In another embodiment, a stacking pouch includes a hook connection hole, and one side of the hook is connected to the hook connection hole and an opposite side of the hook is connected to one or more of the meshes of the securing net. The stacking pouch includes a protrusion protruding by a predetermined length from a side surface thereof. The hook connection hole is formed on the protrusion and having a size allowing the hook to pass therethrough. Two neighboring stacking pouches are disposed adjacent to each other side by side and interconnected by the hook.

In further another embodiment, the tree-planting structure device further includes a connecting plate for vertically connecting an upper stacking pouch with a lower stacking pouch. The connecting plate includes a first set of projections formed on one surface thereof and a second set of projections formed on an opposite surface thereof. The first set of projections is press-fitted into the upper stacking pouch, and the second set of projections is press-fitted into the lower stacking pouch. The first set of projections and the second set of projections have a conical shape.

In further another embodiment, a space is formed between the guard and the securing net, or between the ground and the securing net, where filling soils are disposed in the space between the guard and the securing net, or between the ground and the securing net, to support the stacking pouches.

In further another embodiment, the tree-planting structure device further includes a plurality of protecting pouches disposed on the guard along a longitudinal direction of the guard and containing soils for growing plants. The securing net is configured to cover the guard and the protecting pouches. In other embodiments, the tree-planting structure device further includes a water supply pipe disposed on the protecting pouches to allow water to flow therein.

In another embodiment, a tree-planting structure device includes a securing member, a plurality of stacking pouches, a first fastening member, and a second fastening member. The securing member covers a base support structure. The plurality of stacking pouches is coupled to the securing member and arranged to cover the securing member. Each stacking pouch includes a sack containing soils for growing plants. The first fastening member couples a stacking pouch to the securing member, and the second fastening member couples two neighboring stacking pouches.

In further another embodiment, the plurality of stacking pouches includes a first group of stacking pouches arranged to be side by side and a second group of stacking pouches stacked on top of each other in a vertical direction to a ground.

In further another embodiment, the first group of stacking pouches is coupled to each other via the first fastening member and the second group of stacking pouches is coupled to each other via the second fastening member.

In further another embodiment, the plurality of stacking pouches is positioned along an inclined surface of the securing member. In further another embodiment, one or more stacking pouches contain plant growing soils, a plurality of elastic members and a plurality of absorbers.

In further another embodiment, the tree-planting structure device includes an anchor coupled to the base support structure and securing a position of the securing member relative to the base support structure. The securing member comprises a plurality of meshes and the anchor fastens the securing member to the base support structure at two or more locations through one or more meshes. The first fastening member fastens the stacking pouch to the securing member using one or more meshes.

In further another embodiment, a tree-planting structure device includes a support structure and a plurality of stackable containers. The support structure includes one or more surfaces for supporting tree-planting. The plurality of stackable containers is coupled to the surfaces and includes soils for growing plants. A stackable container includes a mesh structure having a mesh size blocking soil particles to pass through and permitting plants to grow therethrough. The stackable containers are stacked side by side by using a first fastening member and stacked vertically to a ground by using a second fastening member.

In further another embodiment, the stackable containers are stacked along the surfaces of the support structure and fastened to the surfaces via the first fastening member.

In further another embodiment, the mesh structure of the stackable containers further permits moisture and nutrients to enter therethrough and the stackable containers further includes a plurality of elastic members and a plurality of absorbers.

In further another embodiment, the support structure further includes a securing net configured to cover a base structure, an anchor for securing a position of the securing net to the base structure, and filling member contained in a space between the securing net and the base structure.

In further another embodiment, the support structure further includes an inclined surface, a straight surface, or both, based on a shape of the base structure. The stackable containers are fastened to the inclined surface, the straight surface, or both with the first fastening member and the second fastening member.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is a cross-sectional view showing a tree-planting structure device, according to embodiments described herein.

FIG. 2 is another cross-sectional view showing a tree-planting structure device, according to embodiments described herein.

FIG. 3 is a perspective view of the tree-planting structure device shown in FIG. 1, according to embodiments described herein.

FIG. 4 depicts an enlarged view of an anchor 20 shown in FIGS. 1 to 2, according to embodiments described herein.

FIG. 5 further depicts an enlarged view of the anchor 20 shown in FIGS. 1 to 3, according to embodiments described herein.

FIG. 6 depicts a stacking pouch constituting a tree-planting structure device, according to embodiments described herein.

FIG. 7 is a plan view showing the stacking pouch of FIG. 6, according to embodiments described herein.

FIG. 8 is a sectional view showing the stacking pouch of FIG. 6, according to embodiments described herein.

FIG. 9 depicts a hook 60, according to embodiments described herein.

FIG. 10 depicts a state of coupling a stacking pouch to a securing net by using a hook, according to embodiments described herein.

FIG. 11 depicts a state of stacking pouches connected to each other in a horizontal direction, according to embodiments described herein.

FIG. 12 is a perspective view showing a connecting plate for fixing stacking pouches therebetween in a tree-planting structure device, according to embodiments described herein.

FIG. 13 is a sectional view of the connecting plate of FIG. 12, according to embodiments described herein.

FIG. 14 depicts a state of using the connecting plate of FIG. 12, according to embodiments described herein.

FIG. 15 depicts an example of a water supply pipe used in the tree-planting structure device, according to embodiments described herein.

FIG. 16 depicts a state of using the water supply pipe of FIG. 15, according to embodiments described herein.

FIG. 17 depicts states of a tree-planting structure device which is installed at a foothill, according to embodiments described herein.

FIG. 18 further depicts states of a tree-planting structure device which is installed at a foothill, according to embodiments described herein.

FIG. 19 depicts an enlarged view of the tree-planting structure device as shown in FIG. 18, according to embodiments described herein.

FIG. 20 depicts states of a tree-planting structure device which is installed on a concrete outer wall, according to embodiments described herein.

FIG. 21 further depicts states of a tree-planting structure device which is installed on a concrete outer wall, according to embodiments described herein.

FIG. 22 depicts a state of a tree-planting structure device which is installed on a rock cliff, according to embodiments described herein.

### DETAILED DESCRIPTION

Embodiments disclosed herein include systems and methods for providing a tree-planting structure device. In one embodiment, a device for stably tree-planting in connection with various structures such as a concrete outer wall of an apartment, a foothill having a slope, and a structure installed at the center of a road, is provided. The tree-planting structure device includes a securing net formed to have a size adapted to cover various base structures, such as a part of a guard, a ground, or a building outer wall. The securing net may have an array of a plurality of meshes. The tree-planting structure device further includes an anchor coupled to the guard, the ground or the building outer wall to fix a position of the securing net, a plurality of stacking pouches fastened to the mesh constituting the securing net. Each of the stacking pouches is filled with soils for growing plants and stacked while coming into contact with the securing net. The tree-planting structure device further includes a hook serving as a member for fastening the stacking pouch to the mesh of the securing net and connecting the stacking pouch to the securing net.

According to embodiments of the tree-planting structure device described herein, the stacking pouches are stacked along at least one surface of the securing net in a state that the road guard is covered with securing net, and the securing net is anchored by using the anchor. Seeds contained in the stacking pouch can be naturally germinated, thereby tree-planting in or around various structures such as concrete walls and foothills. This may allow any type of existing concrete structures, foothills and road guards to be afforested. Some embodiments include systems and methods for providing the tree-planting structure device incorporating the same will be described in more detail, below.

In another embodiment, a tree-planting structure device includes a securing member, a plurality of stacking pouches, a first fastening member, and a second fastening member. The securing member covers a base support structure. The plurality of stacking pouches is coupled to the securing member and arranged to cover the securing member. Each stacking pouch includes a sack containing soils for growing plants. The first fastening member couples a stacking pouch to the securing member, and the second fastening member couples two neighboring stacking pouches.

In yet another embodiment, a tree-planting structure device includes a support structure and a plurality of stackable containers. The support structure includes one or more surfaces for supporting tree-planting. The plurality of stackable containers is coupled to the surfaces and includes soils for growing plants. A stackable container includes a mesh structure having a mesh size blocking soil particles to pass through and permitting plants to grow therethrough. The stackable containers are stacked side by side by using a first fastening member and stacked vertically by using a second fastening member.

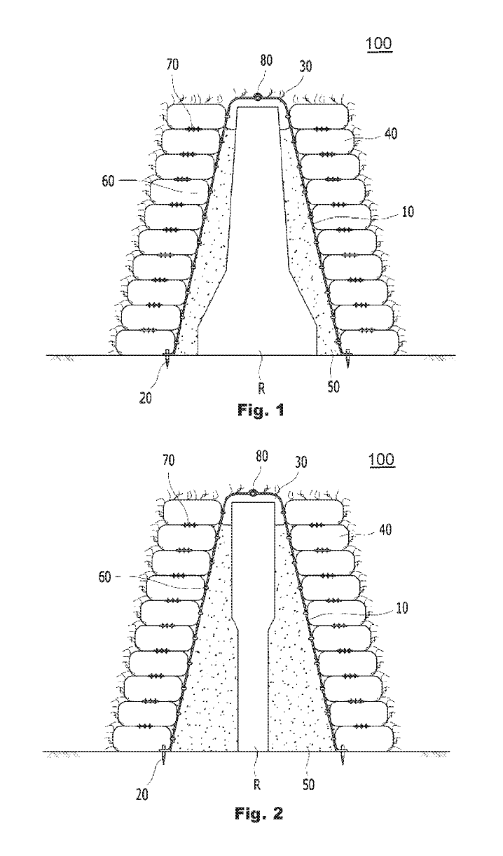

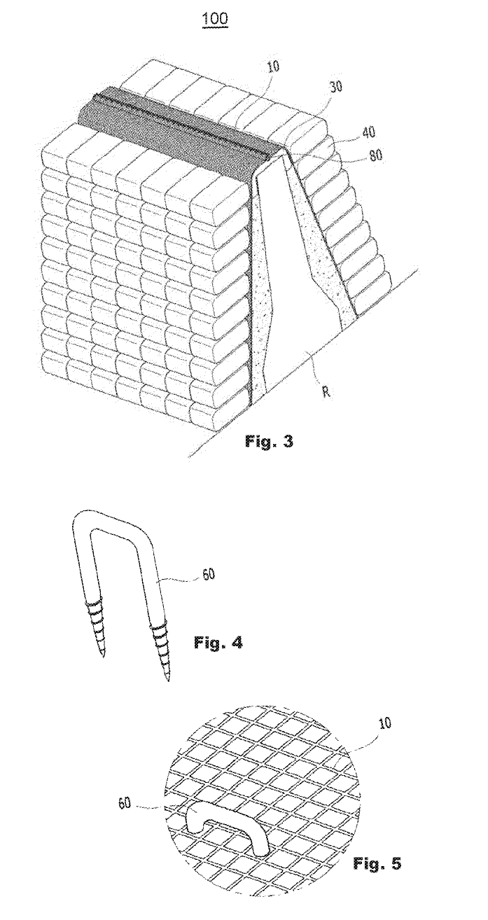

FIGS. 1 and 2 are cross-sectional views showing tree-planting structure devices according to embodiments described herein. FIG. 3 is a perspective view of the tree-planting structure device shown in FIG. 1. More specifically, FIGS. 1 and 2 show tree-planting structure devices installed in different types of road guards. The road guards are marked with “R” in FIGS. 1 to 3.

Referring to FIGS. 1 to 3, the tree-planting structure device 100 may include a securing net 10, a plurality of anchors 20, a plurality of stacking pouches 40, filling soils 50, a plurality of hooks 60, a plurality of connecting plates 70, a protecting pouch 30, and a water supply pipe 80. FIG. 3 illustrates that when the tree-planting structure device 100 is installed/constructed, grasses or flowers germinated from the protecting pouch 30 and the stacking pouch 40 grow up in several weeks or months later as shown in FIGS. 1 and 2.

In some embodiments, the protecting pouch 30 and the stacking pouch 40 are formed of a geotextile material having durability and a textile for enabling water to pass and flow through the protecting pouch 30 and the stacking pouch 40 and germinating the seeds. In addition, the protecting pouch 30 and the stacking pouch 40 may contain fine soil particles, planting seeds to be germinated, and the like.

The securing net 10 has a flexible grid form, and covers a building outer wall, a foothill, a road guard installed in the center or outer side of the road which are required to be afforested by using a plurality of stacking pouches. The building outer wall, the foothill, the road guard, etc. forms a base support structure. Accordingly, because the securing net 10 has the flexible grid form and is installed by using a scheme to cover a structure such as the road guard, the securing net can be modified and installed to be suitable for the shape of the road guard regardless of shapes of the road guard as shown in FIGS. 1 and 2.

The securing net 10 serves to fix the stacking pouches 40, and workers may determine a position and an area to be afforested while variously changing a size of the securing net 10. The securing net 10 may be implemented by using a geogrid sheet formed of synthetic resin, a mesh formed of metal, or the like. For example, the securing net 10 may be manufactured by perforating a flat-type sheet formed of synthetic resin such as polyethylene, polyamide, and polyester, or by weaving fibers formed of synthetic resin such as polyethylene, polyamide, and polyester.

FIGS. 4 and 5 are enlarged views of an anchor 20 shown in FIGS. 1 to 2. FIG. 4 is a perspective view of the anchor 20, and FIG. 5 is a view showing a state of using the anchor 20. In some embodiments, the anchor 20 is formed in a “U” shape, and serves to fix the securing net 10 to the building outer wall, the foothill, or the road guard. In other embodiments, the anchor 20 may be formed in different shapes.

For example, in a state that both ends of the securing net 10 are pulled to tighten the securing net 10, the both ends of the securing net 10 are disposed at positions spaced apart from lower ends of the structure such as the road guard, and then the anchors 20 are passed through the ends of the securing net 10 and coupled to surfaces of the road or ground, respectively. In addition, a slope of the securing net 10 covering the road guard is adjusted by adjusting the position to which the anchor 20 is fixed, so that an overall shape of the tree-planting structure device 100 can be determined.

As shown in FIG. 4, both ends of the anchor 20 having the “U” shape may be formed in a screw shape to improve the bonding strength with the surface of the road or ground. As shown in FIG. 5, the ends of the anchor 20 pass through two meshes at both ends of the securing net 10 and are stuck in the surface of the road or ground, so that both ends of the securing net 10 can be fixed to the surface of the road or ground.

When the both ends of the securing net 10 are positioned farther away from the road guard, the slope of the securing net 10 becomes gentler, and when the both ends of the securing net 10 are fixed closer to the road guard, the slope of the securing net 10 becomes steep.

In some embodiments, tree-planting may be performed at the foot of a mountain having a gentle slope. In that case, the securing net 10 is required to be installed at the foothill. Thus, the securing net 10 may be gently installed along the slope of the foothill. The anchor 20 for fixing the position of the securing net 10 may include a steel pipe anchor or a grouting anchor.

In other embodiments, the securing net 10 is required to be installed on an outer wall which is substantially vertical in order to plant trees on an outer wall formed of concrete or bricks as in an apartment or a house. In that case, the anchor 20 may have a material and a shape such as a concrete nail such that the anchor 20 can be coupled to a rigid structure.

In some embodiments, the protecting pouch 30 may be used if necessary in addition to the stacking pouches 40 used for the afforestation to prevent some exposure of the structure. The protecting pouch 30 is a bag containing soils for growing plants, in which the protecting pouches 30 are stacked in a row on the top of the road guard along the longitudinal direction of the road guard, thereby covering the top of road guard. As shown in FIGS. 1 to 3, after the securing net 10 covers on the protecting pouches 30 stacked in a row on the top of the road guard R, the both ends of the securing net 10 are fixed to the surface of the road or ground around the road guard R, thereby covering the road guard R. Each protecting pouch 30 may be formed of a geotextile material having a mesh size that allows water and nutrients for growing the plants to pass through while preventing soil particles therein from passing through. Seeds are sowed or vegetations are planted in the soils contained in the protecting pouch 30, such that plants such as grasses can grow up after coming up from spaces between the meshes of the stacking pouch 40.

Because the road guard R is mainly formed of a material such as concrete and metal, the top of the road guard R may be sharp. Because the road guard R is continuously vibrated due to vehicles passing the road, the securing net 10 may be damaged by friction on the top of the road guard when the securing net 10 comes into direct contact with the top of the road guard. Particularly when the securing net 10 is formed of synthetic resin, the securing net 10 may be easily damaged by the friction on the top of the road guard R. The protecting pouch 30 is inserted between the securing net 10 and the top of the road guard R, thereby serving to prevent the securing net 10 from being damaged by the sharp top of the road guard R. As a result, an aged deterioration of the tree-planting structure device caused by the vibration rarely occurs even though the road guard R is vibrated by the vehicles passing the road, so that the maintenance and repair is almost unnecessary for a long time.

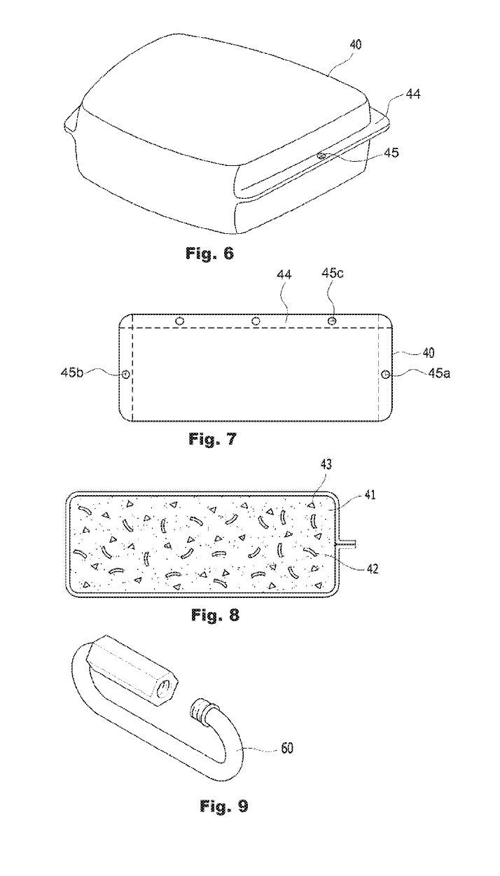

FIG. 6 depicts a stacking pouch 40 constituting a tree-planting structure device of the embodiments described herein. FIG. 7 is a plan view showing the stacking pouch 40 of FIG. 6. FIG. 8 is a sectional view showing the stacking pouch 40 of FIG. 6.

In some embodiments, the stacking pouch 40 is a bag containing the soils for growing plants, in which the stacking pouch 40 is formed on a portion of a side thereof with a protrusion 44 protruding to have a predetermined thickness, and the protrusion 44 is formed therein with a hook connection hole 45 to which a hook is coupled. The stacking pouch 40 may be a stackable container. In some embodiments, the hook operates as a fastening member. In other embodiments, various other fastening members may be used.

In some embodiments, as the hook connection hole 45 is formed in every stacking pouch 40, a hook is coupled between the stacking pouches 40 arranged on the same horizontal plane or on the left and right sides, such that the connections and positions between the stacking pouches can be solidly fixed. Additionally, or alternatively, the stacking pouch 40 is coupled to the securing net 10 by using the hook connection hole 45 formed in the stacking pouch 40 and the hook.

Although FIG. 6 shows that the stacking pouch 40 has the protrusions 44 formed on three sides of the stacking pouch, the shape or structure of the stacking pouch 40 is not limited thereto. In other embodiments, the area or number of portions where the protrusion 44 are formed may be variously changed. In some embodiments, at least one of the hook connection hole 45 may be formed at various positions in the protrusion 44 of the stacking pouch 40. In other embodiments, the hook connection hole 45 may not be formed in the protrusion 44, and the hook connection hole 45 may pass through a body of the stacking pouch 40 or the hook connection hole 45 may be formed in another member attached to the stacking pouch 40.

When the stacking pouches 40 are coupled to the securing net 10 by using the hooks and the hook connection holes, the stacking pouches 40 may be vertically stacked and may be horizontally stacked, as will be described further in detail. When the road guard, such as the median strip, is installed at a center of the road, the stacking pouches 40 may be stacked on two sides of the securing net 10 as shown in FIGS. 1 to 3. When the road guard, such as the guard rail, is installed at an outer side of the road, the stacking pouches 40 may be stacked on only one side of the securing net 10 facing the road. In some embodiments, the stackable containers are stacked side by side by using a first fastening member and stacked vertically by using a second fastening member.

As shown in FIGS. 2-3, the stacking pouches 40 are placed on the surface of the road or ground, while horizontally coming into close contact with each other by the length of the road guard. so as to form the lowest layer of the stacking pouches 40. The stacking pouches 40 may be stacked in a matrix form by repeating a scheme of vertically stacking the same number of stacking pouches 40 on top of the underlying layer of the stacking pouches 40.

In some embodiments, similarly, or identical to each protecting pouch 30, each of the stacking pouches 40 may be formed of a geotextile material having a mesh size that allows water and nutrients for growing the plants to pass through while blocking passage of soil particles therein. In some embodiments, the stackable pouch 40 includes a mesh structure having a mesh size blocking soil particles to pass through and permitting plants to grow therethrough.

As shown in FIG. 7, after a rectangular sheet formed of the geotextile material is folded in half, two of the three sides other than one folded side are sewed, so that the stacking pouch 40 including the protrusion 44 may be fabricated. Then, after the stacking pouch 40 fabricated in the above manner is filled with contents, the remaining side is sewed, so that the fabrication of the stacking pouch 40 may be completed. When the stacking pouch 40 is fabricated in the above manner, three protrusions (flanges) in the form of a double layer are formed.

Although at least one hook connection hole is formed in each of the three protrusions 44 of the stacking pouch 40 as shown in FIG. 7, the hook connection hole may not be formed in each of the protrusions. In some embodiments, the hook connection holes 45a and 45b of two longitudinal protrusions among the three protrusions in the stacking pouch 40 may be used for fastening the stacking pouch to another stacking pouch 40, as shown in FIG. 7. In other embodiments, the hook connection hole 45c in one transverse protrusion may be used for fastening the stacking pouch to the securing net 10. Fastening between the stacking pouches 40 may not be needed due to the gentle inclination of the securing net 10, and in that case, the two longitudinal protrusions 45a and 45b of the stacking pouch 40 may be omitted.

In some embodiments, the number of the hook connection holes in each protrusion of the stacking pouch 40 may vary, and each of the protrusions of the stacking pouch 40 may have one hole or may have three holes as shown in FIG. 7. However, the more hook connection holes are present in each protrusion on the stacking pouch 40, smoother the stacking pouch 40 may be fastened to the securing net 10 or another stacking pouch 40 by using a hole at a more suitable position among multiple connection holes of the stacking pouch 40. Thus, multiple hook connection holes may be formed in each protrusion of the stacking pouch 40 to the extent that the durability of each protrusion of the stacking pouch 40 may not be affected. In a situation where a vehicle deviating from the road happens to collide with at least one of the stacked stacking pouches 40 as described above, the stacking pouch 40 is dented or moved due to an impact caused by the collision with the vehicle, thereby absorbing the impact due to the collision with the vehicle. Accordingly, the plural stacking pouches 40 may absorb and reduce the vehicle collision impact and therefore, injuries to a vehicle driver and damages to the vehicle may be prevented or minimized.

Seeds are sowed or vegetations are planted in the soils contained in the stacking pouch 40, such that the plants such as grasses can grow up after coming out from the meshes of the stacking pouch 40. As the plants in the protecting pouch 30 and stacking pouch 40 grow up, the tree-planting structure device 100 may be covered with the plants. Accordingly, a tree-planting landscape on the road guard can be created by using the tree-planting structure device 100 covered with plants, which may result in reducing the fatigue on the driver's eyes and the radiant heat of the road is reduced and providing a pleasant road environment.

As shown in FIG. 8, the contents of the stacking pouch 40 may be a mixture of plant growing soils 41, a plurality of elastic members 42 for preventing the consolidation of soils in the stacking pouch 40, and a plurality of absorbers 43 for absorbing water in a rainy season and supplying the water to roots of the plants in a dry season. Alternatively, the contents inside the stacking pouch 40 may be a mixture of the plant growing soils 41 and the elastic members 42, or may be a mixture of the plant growing soils 41 and the absorbers 43. In other embodiments, the elastic members 42 may be embodied by using rubber chips obtained by crushing a waste tire. The absorbers 43 may be embodied by using water absorbing polymer crystals widely used for pots or the like.

The soils in the stacking pouch 40 are gradually compressed while the water therein is discharged to the outside due to the load of the other stacking pouches 40 stacked thereon, and the soils are finally denatured into hard soils lacking moisture. Accordingly, the soils 41 inside the stacking pouch 40 may be unsuitable for growing the plants, and rarely absorb the impact due to the collision with the vehicle. The vibrations of the road guard caused by the vehicle passing the road are transferred to the elastic members 42 inside the stacking pouch 40, and the elastic members 42 are slightly vibrated at amplitude larger than that of soil particles due to the elasticity of the elastic members 42. When the elastic members 42 such as rubber chips are uniformly distributed in the soils inside the stacking pouch 40, the soil particles around the elastic members 42 are scattered by the vibration of the elastic members 42, thereby preventing agglomeration between the soil particles.

As shown in FIG. 8, the elastic member 42 has a concave shape having a concave surface arranged upward in the stacking pouch 40. Thus, the elastic member 42 may temporarily store rain water during the rainy season and supply the water to roots of the plants during the dry season. The absorber 43 is designed to have the absorptivity lower than the absorptivity of the root of the plant, such that the water contained in each of the absorbers 43 may be absorbed by the roots of the plants positioned close to the absorber 43. Meanwhile, the elastic member 42 increases the elasticity of the stacking pouch 40, thereby improving the effect of absorbing the vehicle collision impact. Preferably, the elastic members 42 and the absorbers 43 may uniformly distributed in the soils 41 inside the stacking pouch 40 in order to maximize the above-described effect.

In other embodiments, the tree-planting structure device is constructed on an outer wall of a building or house formed of concrete, or a cliff or foothill formed of rocks and therefore, the stacking pouch 40 may not need to buffer the external impact. The stacking pouch 40 may be filled with soils and plant seeds without the elastic members 42.

In some embodiments, the stacking pouch 40 may be coupled to the securing net 10 by using the hook, the stacking pouches arranged in the horizontal left and right directions also may be coupled to each other by using the hook, and the stacking pouches arranged in the vertical up and down directions may be coupled to each other by using a connecting plate described later.

A first coupling between the stacking pouch 40 and securing net 10, a second coupling between the stacking pouches 40 arranged on the same horizontal plane, and a third coupling between the stacking pouches 40 arranged up and down may be provided for constructing the tree-planting structure device. One or more of the first coupling, the second coupling, and the third coupling may be selected according to the construction environment or the inclined angle of the structure. When all of the first to third couplings are used for the construction, it is possible to strongly secure positions of the stacking pouches 40.

Meanwhile, the filling soils 50 (shown in FIGS. 1-2) may further be used in order to fill fine spaces between the stacking pouches 40. In this case, the filling soils 50 serve to additionally supply water and nutrients insufficiently present in the stacking pouch 40 to grow the plants. As mentioned above, although the securing net 10 serves to temporarily fix the stacking pouches 40, the securing net 10 may be collapsed downward due to the load of the stacking pouches 40 especially while multiple stacking pouches 40 are continuously stacked. The filling soils 50 maintains the original shape of the securing net 10 determined by using the anchor 20 despite the load of the stacking pouches 40, so that the tree-planting structure device 100 having the shape designed by the designer of the tree-planting structure device can be constructed.

Referring back to FIGS. 1-3, in a state that the road guard is covered with securing net 10 and the securing net 10 is fixed by using the anchor 20, the space between the stacking pouches 40 and the road guard R are filled with the filling soils 50 while stacking the stacking pouches 40 along the sloped surface of the securing net 10. This allows the tree-planting structure device 100 to accommodate the previously installed road guard. Thus, the tree-planting structure device can be installed on any type of road guard already installed. Accordingly, the tree-planting structure device 100 can be installed on any type of road guard. In addition to the stacking pouches 40 which primarily absorb the vehicle collision impact, the filling soils 50 secondarily absorb the vehicle collision impact, so that injuries to the vehicle driver and damages to the vehicle can be prevented or remarkably reduced.

In addition, the filling soils 50, like the contents inside the stacking pouch 40, may be a mixture of at least one of elastic members for preventing the consolidation of soils in the filling soils 50, a plurality of absorbers for absorbing water during a rainy season and supplying the water to roots of the plants during a dry season, and/or plant growing soils, as described above in conjunction with FIG. 8.

When the composition ratio of the elastic members and the absorbers is higher among the contents of the stacking pouch 40 and the components of the filling soils 50, the soil consolidation prevention effect, the water supply effect, and the impact absorption effect may be improved. However, the composition ratio of the elastic members and the absorbers may be adjusted to the extent that the amount of soils required for growing the plants is sufficient. In some embodiments, the ratio of the soils to the total volume of each stacking pouch 40, which provides the plant growing environment, is higher than the ratio of the soils to the total volume of the filling soils 50, such that the plants can grow normally, while improving the soil consolidation prevention effect, the water supply effect, and the impact absorption effect.

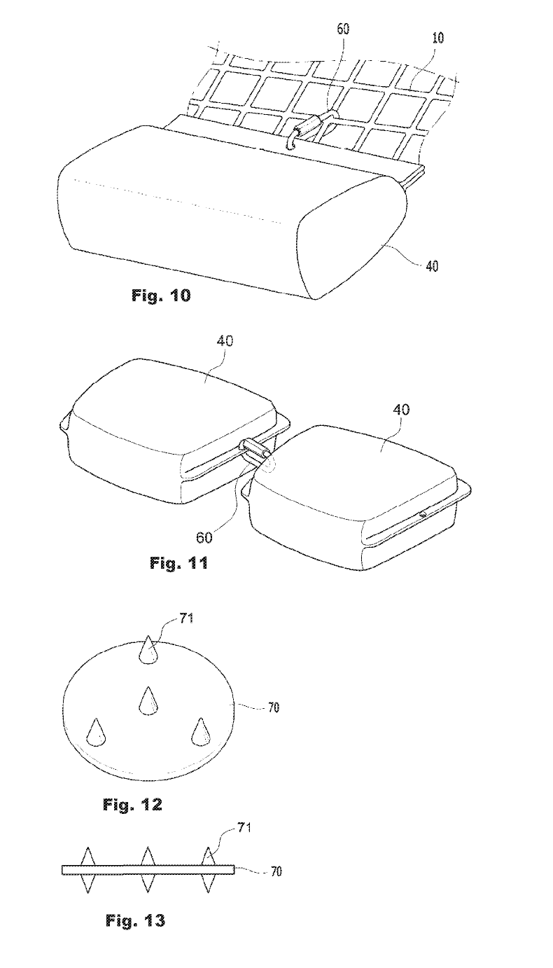

FIG. 9 depicts a hook 60 according to embodiments described herein. FIG. 10 is a view showing a state of a stacking pouch coupled to a securing net by using the hook 60 of FIG. 9 according to embodiments described herein. FIG. 11 depicts a connecting state of stacking pouches 40 in a horizontal direction according to the embodiments described herein. In some embodiments, each of the hooks 60 is formed in an “0” shape, one side of the hook 60 is inserted into the hook connection hole of the stacking pouch 40, and an opposite side of the hook 60 is inserted into the mesh of the securing net 10, so that the stacking pouch 40 is fastened to the securing net 10, as shown in FIG. 10. In this embodiment, the hook 60 is used as a fastening member, but the tree-planting structure device of the embodiments described here may employ various other fastening members available in the art.

Preferably, the hook 60 may be formed of a non-corrosive material such as aluminum and plastic. The hook 60 may be embodied as an “0”-type lock hook as shown in FIG. 9, or may be embodied as another “0”-type hook such as a cable tie. Accordingly, each of the stacking pouches 40 may be moved due to the vehicle collision impact within a range proportional to the sizes of the meshes in the securing net 10 and the size of the inner space of the hook 60 inserted into at least one hole of the stacking pouch 40.

As shown in FIGS. 1 to 3, when the vehicle collides with at least one of the stacking pouches 40 leaning against and sequentially stacked on the inclined surface of the securing net 10, the stacking pouch 40 colliding with the vehicle is pushed and moved by the vehicle. When the sizes of the meshes in the securing net 10 and the size of the inner space of the hook 60 are larger, the range where the hook 60 moves in the meshes of the securing net 10 becomes large, and thus the stacking pouch 40 may move within a wider range. Accordingly, each stacking pouch 40 may be moved in the process of collision with the vehicle, thereby absorbing most of the impact due to the collision with the vehicle, so that damages to the tree-planting structure device, such as burst of the stacking pouch 40 and tearing of the securing net 10 due to the collision with the vehicle, can be remarkably reduced.

Particularly, even though the stacking pouch 40 is moved by the impact due to the collision with the vehicle, the stacking pouch 40 can be prevented from being separated from the tree-planting structure device, because the stacking pouch 40 is merely moved within a range proportional to the sizes of the meshes in the securing net 10 and the size of the inner space of the hook 60 inserted into at least one hole of the stacking pouch 40. As a result, the tree-planting structure device 100 according to the embodiments described herein can maintain overall shape thereof despite collision with the vehicle.

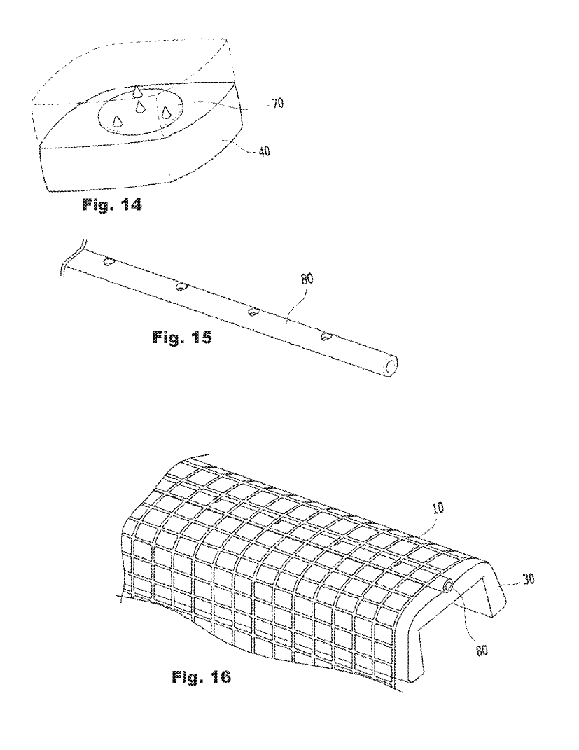

FIG. 12 is a perspective view showing a connecting plate 70 for securing stacking pouches therebetween in the tree-planting structure device 100 according to the embodiments described herein. FIG. 13 is a sectional view of the connecting plate 70 of FIG. 12 and FIG. 14 depicts a state of using the connecting plate 70 of FIG. 12.

The connecting plate 70 has a disk shape having at least one conical projection 71 on both sides thereof, and arranged in the vertical direction as shown in FIGS. 12 and 13, thereby serving to combine the stacking pouches 40 placed in the vertical relation with the stacked position. In other words, the connecting plate 70 is disposed between the two stacking pouches 40 adjacent to each other in the vertical direction among the stacking pouches 40 in the stacked row, and the projections 71 formed on an upper surface and a lower surface of the connecting plate 70 are inserted into the stacking pouches, thereby implementing the connection between the stacking pouches 40 and the connecting plate 70.

In some embodiments, the connecting plate 70 may be formed of a non-corrosive material such as aluminum and plastic. In other embodiments, various other suitable materials are available.

As the connecting plate 70 is pressed by the load of the stacking pouches 40 placed thereon, the conical projections 71 on the lower surface of the connecting plate 70 are press-fitted into the stacking pouch 40 located below the connecting plate 70, so that the stacking pouches 40 in each column are connected to each other. Accordingly, the stacking pouches 40 in each column may move together. Even though the securing net 10, the hook 60, etc. may be damaged, one or more separated stacking pouches 40 may not run away from the column of stacking pouches due to the connections between the upper and lower stacking pouches 40. The stability of the tree-planting structure device 100 according to embodiments described herein may remarkably improve.

As shown in FIG. 12, three conical projections are formed on each sides of the connecting plate 70. In embodiments, the conical projections may be more than three projections, or less than three projections. One or two conical projections may be formed on each sides of the connecting plate 70, or the different number of conical projections may be formed on each sides. However, the stacking pouch 40 may be torn when the size of the conical projection is excessively large, and the stacking pouches 40 in each column may be weakly connected to each other when the size of the conical projection is excessively small. Accordingly, it is preferable that the connecting plate 70 is formed on the both sides thereof with a sufficient number of conical projections having a relatively small size in light of durability of the stacking pouch 40.

FIG. 15 depicts an example of a water supply pipe 80 used in the tree-planting structure device of the embodiments described herein. FIG. 16 illustrates a state of using the water supply pipe 80 of FIG. 15.

In some embodiments, the water supply pipe 80 is formed in a perforated pipe shape as shown in FIG. 15, and may be provided on the protecting pouches 30 stacked in a row on the top of the road guard R (FIG. 16), or may be installed at a place for spraying water toward the stacking pouches 40. The water supply pipe 80 serves to supply water required for the growth of plants to the protecting pouches 30 and the stacking pouches 40 as needed. As shown in FIG. 15, the water supply pipe 80 may be embodied as a perforated pipe having holes formed in a row in a longitudinal direction thereof, or may be embodied as a perforated pipe having holes formed in two rows on both sides in the longitudinal direction thereof. Each hole of the water supply pipe 80 may be a hole which is simply open in a side wall, or may be a nozzle type hole such as a sprinkler.

Because the road may be very dry for a long time due to the radiant heat, some plants cannot survive with only rain water. In some embodiments, water required for the growth of plants is supplied to the protecting pouches 30 and the stacking pouches 40 through the water supply pipe 80 mounted on the protecting pouches 30 arranged in a row at the top of the road guard R, such that the plants can be prevented from withering away during the dry season. Particularly, in some embodiments, the water supply pipe 80 in the form of the perforated pipe is mounted on the protecting pouches 30 without installing complicated irrigation facilities, such that water can be supplied to the protecting pouches 30 and the stacking pouches 40, and thus the plants can be prevented from withering away due to lack of water at a very low cost.

As shown in FIG. 16, after the securing net 10 covers the protecting pouches 30 on which the water supply pipe 80 is mounted so as to place the warp threads of the securing net 10 on the holes of the water supply pipe 80, the both ends of the securing net 10 are fixed to the surface of the road or ground around the road guard R, thereby covering the road guard R. The water discharged through the holes of the water supply pipe 80 flows down through the warp threads of the securing net 10 placed on the holes of the water supply pipe 80 and reaches the stacking pouches 40.

The road guard R may be installed on a road in an area where the water cannot be supplied to the water supply pipe 80 through irrigation facilities or the like. A water tank for receiving and storing rain water in the rainy season is installed around the road guard R, such that the water can be supplied to the water supply pipe 80 from the water tank. In this case, because the amount of water flowing through the water supply pipe 80 is insufficient, a scheme such as a sprinkler to spray water to the stacking pouches 40 may not be suitable. According to the embodiment, the water discharged through the holes of the water supply pipe 80 flows down through the warp threads of the securing net 10 and is supplied to all of the stacking pouches 40, so that the growth of plants may not be hindered even though the amount of water flowing through the water supply pipe 80 is small.

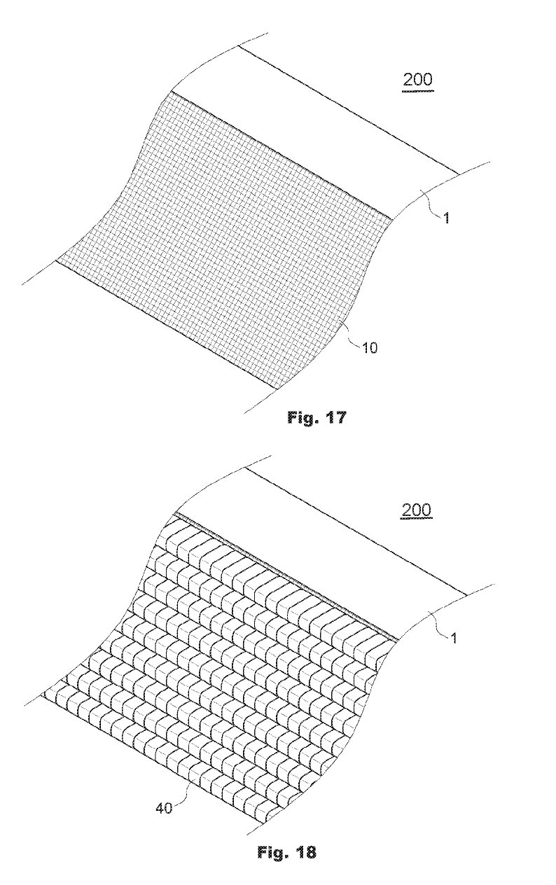

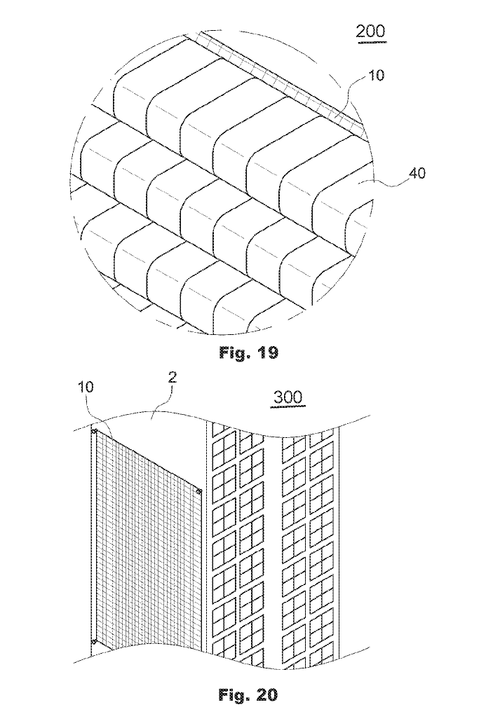

FIGS. 17 to 19 depict states of a tree-planting structure device 200 which is installed at a foothill. Referring to FIGS. 17 to 19, when a place to afforest by planting plants such as flowers and trees is a foothill 1, the above-described securing net 10 is positioned thereon, and the securing net 10 is fixed by using a grouting anchor.

In addition, the stacking pouches 40 are sequentially stacked on the securing net 10 by using the hooks, wherein the hook is coupled to the hook connection hole formed in the stacking pouch 40. In addition, the connecting plate 70 (see FIGS. 12-13) may be interposed between the stacking pouches 40 arranged up and down. The stacking pouches arranged left and right are coupled to adjacent stacking pouches arranged left and right by using the hooks 60 (FIG. 9), and the hooks 60 may not be used if necessary.

FIGS. 20 and 21 illustrate states of a tree-planting structure device 300 which is installed on a concrete outer wall.

Referring to FIGS. 20 and 21, the tree-planting structure device 300 also may be used even when an outer wall 2 of a building structure such as an apartment and a house is required to be tree-planted. Although the above building structure has the surface which has almost 90 degrees, the securing net 10 is fixed to the concrete outer wall 1 by using concrete nails classified as one of the anchors as shown in FIG. 20, and the stacking pouches are connected to the securing net 10 by using the hooks. In other embodiments, the outer wall of the building structure may have an inclined surface.

Because the outer wall of the building structure such as the apartment and the house is almost vertically constructed, the stacking pouches 40 are coupled to the securing net 10 by using the hooks, the stacking pouches 40 arranged side by side and right and left are coupled to each other by using the hooks, and the stacking pouches 40 arranged up and down are connected to each other by using the connecting plate 70, such that the bonding strength between the stacking pouches is increased, as shown in FIG. 21.

In addition, seeds germinated in the stacking pouches 40 gradually expand roots even though the tree-planting structure device 300 is constructed on the above building structure, so that the binding strength between the stacking pouches may be stronger. Actually, the stacking pouches 40 do not fall down or collapse even when the tree-planting structure device is installed on the building outer wall.

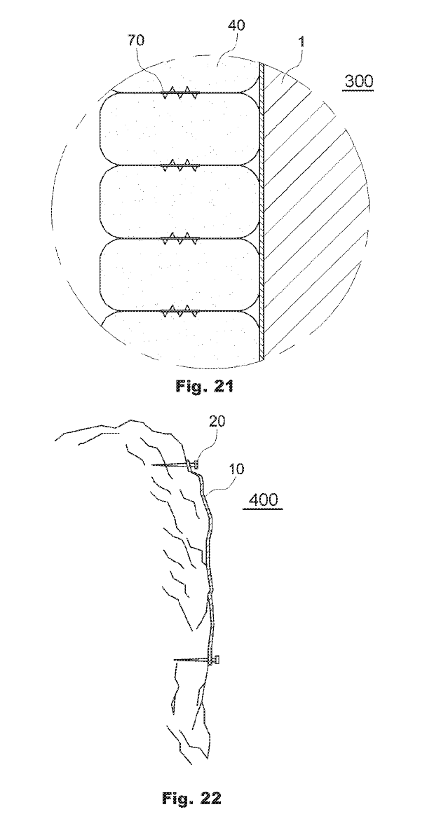

FIG. 22 is a view showing a state of a tree-planting structure device 400 which is installed on a rock cliff. As shown in FIG. 22, the tree-planting also can be applied to a rock cliff in a manner that the securing net 10 is fixed to the cliff formed of rocks by using anchors such as concrete nails 20, and the stacking pouches (not shown) are fixed to the securing net 10 by using the hooks.

As illustrated above, various embodiments of the tree-planting structure device are disclosed. The tree-planting structure device described in the above embodiments may be installed in an outer wall of an apartment or house, a foothill, a road guard, or the like, and a desired place can be easily and conveniently afforested by using the tree-planting structure device.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, and methods for providing the tree-planting structure device. It should also be understood that these embodiments are merely exemplary and are not intended to limit the scope of this disclosure.

What is claimed is:

1. A tree-planting structure device comprising:
a securing net having a size adapted to cover a part of a guard, a ground, or a building outer wall, and having an array of a plurality of meshes;
an anchor coupled to the guard, the ground or the building outer wall to fix a position of the securing net;
a plurality of stacking pouches fastened to the array of the plurality of meshes, the stacking pouches comprising a sack containing soils for growing plants, wherein the stacking pouches are stacked along the securing net while coming into contact with the securing net; and
a hook comprising a member for fastening the stacking pouches to the array of meshes of the securing net.

2. The tree-planting structure device of claim 1, wherein a stacking pouch comprises a hook connection hole; and
one side of the hook is connected to the hook connection hole and an opposite side of the hook is connected to one or more of the meshes of the securing net.

3. The tree-planting structure device of claim 1, wherein a stacking pouch comprises a protrusion protruding by a predetermined length from a side surface thereof; and
a hook connection hole formed on the protrusion and having a size allowing the hook to pass therethrough. and
two neighboring stacking pouches are disposed adjacent to each other side by side and interconnected by the hook.

4. The tree-planting structure device of claim 1, further comprising a connecting plate for vertically connecting an upper stacking pouch with a lower stacking pouch;
wherein the connecting plate comprises a first set of projections formed on one surface thereof and a second set of projections formed on an opposite surface thereof, the first set of projections configured to be press-fitted into the upper stacking pouch, and the second set of projections configured to be press-fitted into the lower stacking pouch.

5. The tree-planting structure device of claim 4, wherein the first set of projections and the second set of projections have a conical shape.

6. The tree-planting structure device of claim 1, wherein a space is formed between the guard and the securing net, or between the ground and the securing net, where filling soils are disposed in the space between the guard and the securing net or between the ground and the securing net, to support the stacking pouches.

7. The tree-planting structure device of claim 1, further comprising a plurality of protecting pouches disposed on the guard along a longitudinal direction of the guard and containing soils for growing plants,
wherein the securing net is configured to cover the guard and the protecting pouches.

8. The tree-planting structure device of claim 7, further comprising a water supply pipe disposed on the protecting pouches to allow water to flow therein.

9. A tree-planting structure device comprising:
a securing member for covering a base support structure;
a plurality of stacking pouches coupled to the securing member and arranged to cover the securing member, a stacking pouch comprising a sack containing soils for growing plants;
a first fastening member that couples the stacking pouch to the securing member; and
a second fastening member coupling two neighboring stacking pouches.

10. The tree-planting structure device of claim 9, wherein the plurality of stacking pouches comprises a first group of stacking pouches arranged to be side by side and a second group of stacking pouches stacked on top of each other in a vertical direction to a ground.

11. The tree-planting structure device of claim 10, wherein the first group of stacking pouches are coupled to each other via the first fastening member and the second group of stacking pouches are coupled to each other via the second fastening member.

12. The tree-planting structure device of claim 9, wherein the plurality of stacking pouches are positioned along an inclined surface of the securing member.

13. The tree-planting structure device of claim 9, wherein one or more stacking pouches contain plant growing soils, a plurality of elastic members and a plurality of absorbers.

14. The tree-planting structure device of claim 9, further comprising an anchor coupled to the base support structure and securing a position of the securing member relative to the base support structure.

15. The three-planting structure device of claim 14, wherein the securing member comprises a plurality of meshes;
the anchor fastens the securing member to the base support structure at two or more locations through one or more meshes; and
the first fastening member fastens the stacking pouch to the securing member using one or more meshes.

16. A tree-planting structure device comprising:
a support structure comprising one or more surfaces for supporting tree-planting; and
a plurality of stackable containers coupled to the surfaces and comprising soils for growing plants, wherein a stackable container comprises a mesh structure having a mesh size blocking soil particles to pass through and permitting plants to grow therethrough;
wherein the stackable containers are stacked side by side by using a first fastening member and stacked vertically by using a second fastening member.

17. The tree-planting structure device of claim 16, wherein the stackable containers are stacked along the surfaces of the support structure and fastened to the surfaces via the first fastening member.

18. The tree-planting structure device of claim 16, wherein the mesh structure of the stackable containers further permits moisture and nutrients to enter therethrough and the stackable containers further comprise a plurality of elastic members and a plurality of absorbers.

19. The tree-planting structure device of claim 16, wherein the support structure further comprises:
a securing net configured to cover a base structure;
an anchor for securing a position of the securing net to the base structure; and
filling members contained in a space between the securing net and the base structure.

20. The tree-planting structure device of claim 19, wherein the support structure further comprises an inclined surface, a straight surface, or both, based on a shape of the base structure, and the stackable containers are fastened to the inclined surface, the straight surface, or both with the first fastening member and the second fastening member.
